(19) United States
(12) Patent Application Publication
(10) Pub. No.: US 2019/0130343 A1
(43) Pub. Date: May 2, 2019

(54) BAGGAGE COLLECTION AND DELIVERY SYSTEM

(71) Applicant: TOYOTA JIDOSHA KABUSHIKI KAISHA, Toyota-shi (JP)

(72) Inventors: Koji TAGUCHI, Sagamihara-shi (JP); Makoto MORITA, Mishima-shi (JP)

(73) Assignee: TOYOTA JIDOSHA KABUSHIKI KAISHA, Toyota-shi (JP)

(21) Appl. No.: 16/112,906

(22) Filed: Aug. 27, 2018

(30) Foreign Application Priority Data
Oct. 26, 2017 (JP) 2017-207501

(51) Int. Cl. G06Q 10/08; G05D 1/00; G07B 15/02

(52) U.S. Cl. CPC G06Q 10/083; G05D 2201/0213; G07B 15/02; G05D 1/0088

(57) ABSTRACT

A baggage α of a user UA is delivered from a position P1 to a position P2. A collection task of the baggage α at the position P1 is carried out at time T1. A handover task of the baggage α at the position P2 is carried out at time T2. From time T1 to time T2, a transportation service of a user UC is carried out. The transportation task of the user UC is carried out from a position P3 to a position P4. A pickup task of the user UC at the position P3 is carried out at time T3. A drop-off task of the user UC at the position P4 is carried out at time T4.

### CROSS-REFERENCE TO RELATED APPLICATION

The present disclosure claims priority under 35 U.S.C. § 119 to Japanese Patent Applications No. 2017-207501, filed on Oct. 26, 2017. The contents of these applications are incorporated herein by reference in their entirety.

### TECHNICAL FIELD

The present disclosure relates to a system in which a baggage of a user is collected and delivered by using an automatic drive vehicle capable of autonomous travel.

### BACKGROUND

JP 2017-59254 A discloses an automatic drive vehicle capable of autonomous travel. The automatic drive vehicle is configured to generate information on automatic driving operation to a destination designated by a user based on various information acquired from radars, a camera group, a sensor group and OPS satellites. The automatic drive vehicle is also configured to control a motor drive portion and a steering drive portion based on the information on automatic driving operation.

Such an automatic drive vehicle comprises has a space for ride and a space for baggage, as well as a non-automatic drive vehicle. In a transportation service of a user by using the automatic drive vehicle, the user puts his/her baggage in the space for baggage at a pickup point and then gets inside the space for ride to head for a drop-off point. Sometimes the user does not use the space for baggage.

In a baggage collection and delivery service by using the automatic drive vehicle, the user puts his/her baggage in the space for baggage at a baggage leaving point and takes the baggage from the space for baggage at a baggage receiving point. In some cases, the user who requests the collection and delivery of the baggage is different from the user who takes the baggage at the baggage receiving point.

Herein, there is a problem in the collection and delivery service that the space for ride is unattended while the automatic drive vehicle only delivers baggage. Therefore, it is desirable to devise measures to raise occupancy rate of the space for ride.

The present disclosure addresses the above described problem, and an object of the present disclosure is, to provide measures to raise occupancy rate of the space for ride in the case of the collection and delivery service.

### SUMMARY

A first aspect of the present disclosure is a baggage collection and delivery system for solving the problem described above and has the following features.

The baggage collection and delivery system comprising:

a plurality of automatic drive vehicles, each of which is configured to travel autonomously and includes a space for baggage and a space for ride;

a mobile terminal belonging to a user; and

a management center which is configured to communicate via a network to the automatic drive vehicle and the mobile terminal.

The management center is further configured to:

when receiving a request for collection and delivery including a collection address and a delivery address of a baggage from the mobile terminal of a first user, select from the automatic drive vehicles a vehicle for collection and delivery whose the space for baggage and the space for ride are available;

transmit to the vehicle for collection and delivery an instruction for collection and delivery based on the request for collection and delivery;

when receiving a request for transportation including a pickup point and drop-off point baggage from the mobile terminal of a second user, select from the automatic drive vehicles a vehicle for transportation whose the space for ride is at least available; and

transmit to the vehicle for transportation an instruction for transportation based on the request for transportation.

The vehicle for collection and delivery is configured to:

when receiving the instruction for transportation while performing a delivery task of the baggage in accordance with the instruction for collection and delivery, perform a transportation task of the second user in accordance with the instruction for transportation in priority to the delivery task; and

perform the delivery task after the completion of the transportation task.

A second aspect of the present disclosure has the following features according to the first aspect.

The collection and delivery request further includes a receipt time of the baggage at the delivery address.

The management center is further configured to, in the selection processing, when a candidate of the vehicle for transportation is the vehicle for collection and delivery, determine, based on time required for the transportation task, on whether the candidate reaches the delivery address before the receipt time of the baggage.

A third aspect of the present disclosure has the following features according to the first aspect.

The request for collection and delivery further includes information on whether or not parallel processing of a baggage delivery task and a user transportation task is permitted.

The management center is further configured to, when the approval information on parallel processing is included in the collection and delivery request, transmit to the mobile terminal of the first user basic charge and discount of a service by the vehicle for collection and delivery.

A fourth aspect of the present disclosure has the following features according to the first aspect.

The request for transportation further includes information on whether or not parallel processing of a baggage delivery task and a user transportation task is permitted.

The management center is further configured to, when the approval information on parallel processing is included in the request for transportation, transmit to the mobile terminal of the second user basic charge and discount of a service by the vehicle for transportation.

According to the first aspect, when the vehicle for collection and delivery receives the instruction for transportation during the delivery task, the transportation task according to the instruction for transportation is carried out in preference to the delivery task. Therefore, it is possible to utilize the space for ride effectively and hence to raise the occupancy rate of the space for ride.

According to the second aspect, when the candidate is the vehicle for collection and delivery, determination on whether the candidate reaches the delivery address before the receipt time of the baggage (i.e. handover time of the baggage by the vehicle for collection and delivery) based on time required for the transportation task. Therefore, for example, if the result of the arrival determination is negative, the management center is able to suspend selecting the candidate as the vehicle for transportation. Therefore, it is possible to avoid a situation in which the vehicle for collection and delivery is delayed in the handover time.

According to the third aspect, when the approval information on parallel processing is included in the request for collection and delivery, basic charge and discount of the service by the vehicle for collection and delivery are transmitted to the mobile terminal of first user. Therefore, when the first user permits the parallel processing, it is possible for the first user to enjoy the benefit of the parallel processing.

According to the fourth aspect, when the approval information on parallel processing is included in the request for transportation, basic charge and discount of the service by the vehicle for transportation are transmitted to the mobile terminal of second user. Therefore, when the second user permits the parallel processing, it is possible for the second user to enjoy the benefit of the parallel processing.

### BRIEF DESCRIPTION OF DRAWINGS

FIG. 1 is a diagram for showing a configuration of a baggage collection and delivery system according to each embodiment of the present disclosure;

FIG. 2 is a diagram for explaining an example of a basic flow of collection and delivery service assumed by the baggage collection and delivery system according to a first embodiment of the present disclosure;

FIG. 3 is a diagram for explaining an example of a basic flow of processing of the baggage collection and delivery system (a user UA) according to the first embodiment;

FIG. 4 is a diagram for explaining an example of a basic flow of processing of the baggage collection and delivery system (a management center) according to the first embodiment;

FIG. 5 is a diagram for explaining an example of a basic flow of processing of the baggage collection and delivery system (an automatic travel vehicle) according to the first embodiment;

FIG. 6 is a diagram for explaining features of the baggage collection and delivery system according to first embodiment;

FIG. 7 is a diagram for explaining an example of a flow of processing when the baggage collection and delivery system (a user UC) according to the first embodiment performs a transportation service;

FIG. 8 is a diagram for explaining an example of a flow of processing when the baggage collection and delivery system (the management center) according to the first embodiment performs the transportation service;

FIG. 9 is a diagram for explaining an example of a flow of processing when the baggage collection and delivery system (the automatic travel vehicle) according to the first embodiment performs the transportation service;

FIG. 10 is a diagram for explaining an example of a basic flow of collection and delivery service assumed by the baggage collection and delivery system according to a second embodiment of the present disclosure;

FIG. 11 is a diagram for explaining an example of a basic flow of processing of the baggage collection and delivery system (a user UD) according to the second embodiment;

FIG. 12 is a diagram for explaining an example of a basic flow of processing of the baggage collection and delivery system (the management center) according to the second embodiment.

FIG. 13 is a diagram for explaining an example of a basic flow of processing of the baggage collection and delivery system (the automatic travel vehicle) according to the second embodiment;

FIG. 14 is a diagram for explaining features of the baggage collection and delivery system according to second embodiment;

FIG. 15 is a flowchart for showing a flow of processing in the management center constituting the baggage collection and delivery system of a third embodiment of the present disclosure;

FIG. 16 is a flowchart for showing a flow of processing in the mobile terminal of the user UA constituting the baggage collection and delivery system of the third embodiment;

FIG. 17 is a flowchart for showing a flow of processing in the management center constituting the baggage collection and delivery system of the third embodiment; and

FIG. 18 is a flowchart for showing a flow of processing in the mobile terminal of the user UC constituting the baggage collection and delivery system of the third embodiment.

### DESCRIPTION OF EMBODIMENTS

Hereinafter, embodiments of the present disclosure will be described based on the accompanying drawings. Note that elements that are common to the respective drawings are denoted by the same reference characters and a duplicate description thereof is omitted. Further, the present disclosure is not limited to the embodiments described hereinafter.

### First Embodiment

### 1. Configuration of a Baggage Collection and Delivery System

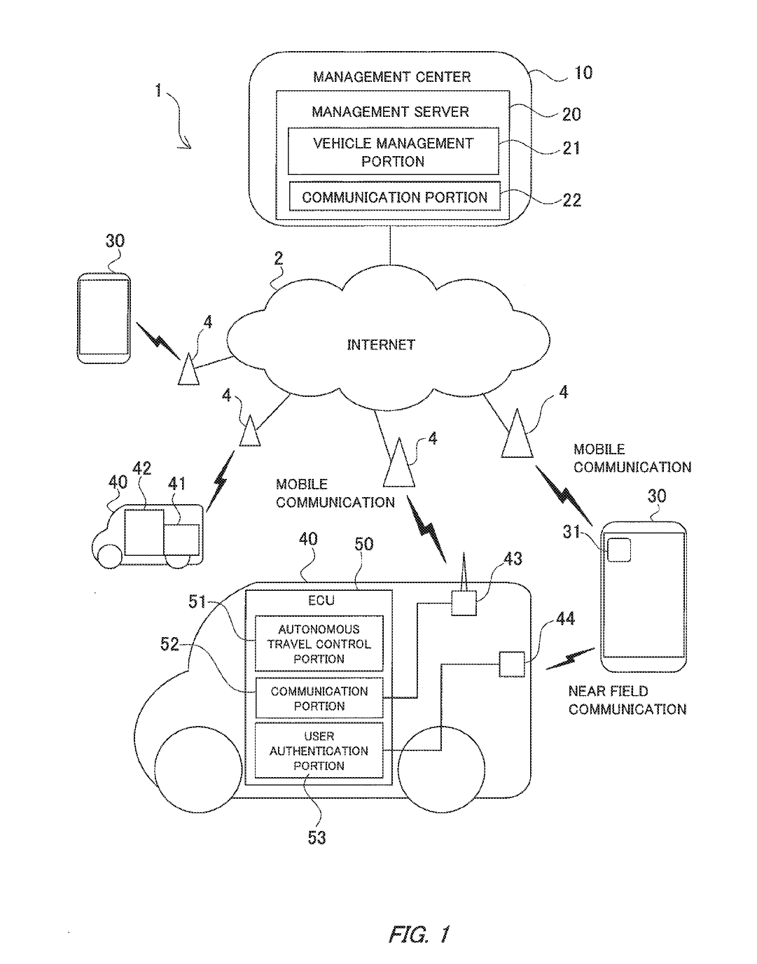

A baggage collection and delivery system according to a first embodiment of the present disclosure is a system in which an automatic drive vehicles are used to realize a collection and delivery service for a baggage. FIG. 1 is a diagram for showing a configuration of the baggage collection and delivery system according to the first embodiment. Note that the configuration of a baggage collection and delivery system 1 shown in FIG. 1 is common not only to the first embodiment but also to second and third embodiments described later.

The baggage collection and delivery system 1 shown in FIG. 1 comprises automatic travel vehicles (hereinafter also simply referred to as a “vehicle” or “vehicles”) 40, a mobile terminal 30 owned by a user and a management center 10 which communicates the vehicles 40 and the mobile terminal via a network (i.e. internet). The number of the vehicles 40 constituting the baggage collection and delivery system 1 is at least two. Each of the vehicles 40 is configured to travel autonomously and includes a space for baggage 41 and a space for ride 42. The space for baggage 41 is for example a trunk the vehicle 40. The space for ride 42 is a compartment of the vehicle 40. The compartment of the vehicle may be divided by a partition into the space for baggage 41 and the space for ride 42.

The management center 10 is a facility operated by a provider that provides the transportation service. However, it is unnecessary for the provider to be resident in the management center 10 and a management server 20. That is, it is sufficient at least a management server 20 is installed in the management center 10. The management server 20 itself may be the management center 10. The management server 20 is a computer having at least one processor and at least one memory. In the memory, at least one program for the collection and delivery service and various data are stored. When the program stored in the memory is read out and executed by the processor, the management server 20 implements various functions represented by blocks in FIG. 1.

The management server 20 is provided with a large-capacity storage device such as HDD and SSD. Various databases are built in the storage device. Various databases include a database for storing information on users who use the collection and delivery service (for example, user ID information), a database for storing map information and road traffic information on areas providing collection and delivery service, and a database for storing status information of the vehicles 40. The status information of the vehicles 40 includes not only travel information (for example, running area, diagnosis) but also usage state of the space for baggage 41 and space for ride 42.

A usage status (41, 42) of the space for baggage 41 and the space for ride 42 is managed by bit strings of “0” and “1”, for example. When only the space for baggage 41 is in use, the use status (41, 42) is expressed as (1, 0). When both spaces are in use, the usage status (41, 42) is expressed as (1, 1). When both spaces are not in use, the usage status (41, 42) is expressed as (0, 0). When only the space for ride 42 is in use, the usage status (41, 42) is expressed as (0, 1). In the following description, when it is necessary to distinguish the use status (41, 42), it is expressed by combining the vehicle 40 with the bit strings as the vehicle 40 (0, 0) or the like.

The management server 20 is connected to the network 2. The management server 20 is configured to communicate with the vehicles 40 via the network 2. The management server 20 is also configured to communicate with the user's mobile terminal 30 via the network 2. In FIG. 1, the function for the transportation service of the management server 20 is represented by a plurality of blocks. The blocks correspond to a vehicle management portion 21 and a communication portion 22.

The vehicle management portion 21 is configured to execute processing to accept a request for collection and delivery of a baggage (hereinafter also referred to as “(A) Reception processing”), processing to select a vehicle for collection and delivery (hereinafter also referred to as “(B) Selection processing”) and processing to generate information on collection and delivery of the baggage (hereinafter also referred to as “(C) Generation processing”).

(A) Reception processing is processing to accept the request for collection and delivery transmitted from the mobile terminal 30 of the user via the network 2. The request for collection and delivery accepted by (A) Reception processing includes, for example, the following information on (i) to (vi).

(i) user ID information of a sender of the baggage (hereinafter also referred to as a “user UA”)
(ii) a collection address of the baggage (hereinafter also referred to as a “baggage leaving point”)
(iii) a delivery address of the baggage (hereinafter also referred to as a “baggage receiving point”)
(iv) user ID information of a receiver of the baggage (hereinafter also referred to as a “user UB”)
(v) leaving time at which the user UA wants to send the baggage (hereinafter also referred to as “baggage leaving time”)
(vi) receipt time at which the user UA wants to deliver the baggage (hereinafter also referred to as “baggage receiving time”)

If the user UA and the user UB are the same user, (iv) user ID information of the user UB may not be included in the request for collection and delivery. The same may be applied to a case where the user UA and the user UB are different users, since the user UA often does not know (iv) user ID information of the user UB. If the user UA does not know (iv) user ID information of the user UB, (iv) user ID information of the user UB may not be included in the request for collection and delivery. However, in this case, (iv) user ID information of the user UB may be specified by the vehicle management portion 21. Based on the user ID information accumulated in the database of the management server 20, for example, the vehicle management portion 21 extracts candidates of users related to the baggage receiving point and presents them to the user UA. Then, when one of the candidates is selected by the user UA, the vehicle management portion 21 identifies the candidate's ID information as (iv) user ID information of the user UB.

(B) Selection processing is processing to select a vehicle for collection and delivery of the baggage based on the request for collection and delivery and information stored in the database of the management server 20. In (B) Selection processing, at first, the vehicles 40 (0, 0) which are able to reach (ii) baggage leaving point by (v) baggage leaving time are extracted. The vehicles (40) which are engaged in a collection task of the other baggage are excluded from this extraction. Subsequently, one vehicle 40 (0, 0) with the shortest autonomous travel time of a route to (ii) baggage leaving point is selected for the vehicle for collection and delivery from the candidates. The autonomous travel time is calculated under an assumption that each of the candidates normally travels a route from its present point to (ii) baggage leaving point.

(C) Generation processing is processing to generate the information on collection and delivery which is transmitted to the vehicle for collection and delivery and also to the mobile terminals 30 of the users UA and UB. The information for the vehicle for collection and delivery includes an instruction for collection and delivery. The instruction for collection and delivery includes, for example, (i) user ID information of the user UA, (ii) baggage leaving point, (iii) baggage receiving point and (iv) user ID information of the user UB. The information for the mobile terminal 30 of the user UA includes, for example, ID information of the vehicle for collection and delivery and estimated times at which the same vehicle reaches (ii) baggage leaving point and (iii) baggage receiving point, respectively. The information for the mobile terminal 30 of the user UB includes, for example, ID information of the vehicle for collection and delivery and estimated time at which the same vehicle reaches (iii) baggage receiving point. The estimated time at which the vehicle for collection and delivery reaches (ii) baggage leaving point is calculated under an assumption that the same vehicle travels normally a route from its present point to (ii) baggage leaving point. The estimated time at which the vehicle for collection and delivery reaches (iii) baggage receiving point is calculated under an assumption that the same vehicle normally travels a route from (ii) baggage leaving point to (iii) baggage receiving point.

The communication portion 22 is configured to transmit the information on collection and delivery described above to the mobile terminals 30 of the users UA and UB and the vehicle for collection and delivery via the network 2.

The mobile terminal 30 is a wireless communication terminal capable of wireless communication with the base stations 4 on the network 2, for example, a smartphone. The communication standard of the wireless communication used by the mobile terminal 30 may be a mobile communication standard such as 4G, LTE, 5G, or the like. In the mobile terminal 30, an application 31 for the transportation service is installed. When the user starts up the application 31, it is possible for the user to connect to transmit the request for collection and delivery to the management center 10.

The mobile terminal 30 preferably includes a chip (not shown) of Near Field Communication such as Wi-Fi, Bluetooth (registered trademark) or the like. Near Field Communication is used for authentication between the mobile terminal 30 and the vehicles 40. However, if different means are used for the authentication, the function of Near Field Communication is not required.

Each of the vehicles 40 is configured to travel autonomously a route from its present area to a destination based on the information on collection and delivery and various information described above. The various information for autonomous travel includes external information for recognizing external conditions of the vehicle 40 obtained by external sensors such as camera sensor and millimeter wave sensor. The various information for autonomous travel includes internal information for recognizing the state of the vehicle 40 obtained by internal sensors such as a vehicle speed sensor and an acceleration sensor. The various information for autonomous travel includes GPS information indicating the present area obtained by a GPS receiver. The various information for autonomous travel includes map information stored in the map database.

Each of the vehicles 40 includes a communication device for network 43 and a communication device for authentication 44. The communication device for network 43 and the communication device for authentication 44 are connected to an electronic control unit (hereinafter also referred to as an “ECU”) 50. The ECU 50 has at least one processor and at least one memory. In the memory, at least one program for autonomous travel and various data are stored. When the program stored in the memory is read out and executed by the processor, the ECU 50 implements various functions represented by blocks in FIG. 1. The ECU 50 may be composed of a plurality of ECUs.

In FIG. 1, among the functions for the autonomous travel of the ECU 50, the functions related to the collection and delivery service are represented by a plurality of blocks. The blocks correspond to an autonomous travel control portion 51, an air conditioning control portion 52, a communication portion 52 and a user authentication portion 53. The autonomous travel based on the above various information is realized by the autonomous travel control portion 51. For example, the autonomous travel control portion 51 calculates a traveling route based on the information on collection and delivery, the GPS information of the vehicle 40, and map information of the vehicle 40. The autonomous travel control portion 51 controls driving, steering and braking of the vehicle 40 so that the vehicle 40 autonomously travels along the calculated traveling route. There are various known methods for the autonomous travel, and in the present disclosure there is no limitation on the method for the autonomous travel. The autonomous travel of the route from the present area to (ii) baggage leaving point, a collection task of the baggage at (ii) baggage leaving point, a delivery task of the baggage and a handover task of the baggage at (iii) baggage receiving point are performed by the autonomous travel control portion 51.

The communication portion 52 is configured to connect to the network 2 with the communication device for network 43. Specifically, wireless communication is carried out between the communication device for network 43 and nearest base station 4, and the communication device for network 43 is connected to the network 2 via the nearest base station 4. The communication standard of the wireless communication used by the communication device for network 43 may be a mobile communication standard such as 4G, LTE, 5G, or the like. On the network 2, a connection destination of the communication portion 52 is the communication portion 22 of the management server 20. From the communication portion 52 to the communication portion 22, for example, external information obtained by the external sensors, internal information obtained by the internal sensors, and GPS information obtained by the GPS receiver are transmitted. From the communication portion 22 to the communication portion 52, for example, the information on collection and delivery is transmitted.

The user authentication portion 53 is configured to communicate wirelessly with the mobile terminal 30 with the communication device for authentication 44. The communication standard used by the communication device for authentication 44 may be a standard capable of wireless communication at a short distance such as Wi-Fi, Bluetooth (registered trademark) or the like. The user authentication portion 53 performs Near Field Communication with the mobile terminal 30 located in the vicinity of the vehicle 40 and directly obtains ID information (for example, a PIN code) of the mobile terminal 30. Then, the user authentication portion 53 compares the obtained ID information with (i) user ID information of the user UA (or (iv) user ID information of the user UB) obtained from the management server 20 by Near Field Communication. If the two information match, the user authentication portion 53 authenticates the user of the mobile terminal 30 as the user UA (or the user UB). The user authentication performed by the user authentication portion 53 is used as, for example, conditions of the door lock release of the vehicle 40 at (ii) baggage leaving point or (iii) baggage receiving point.

### 2. Example of a Basic Flow of the Collection and Delivery Service

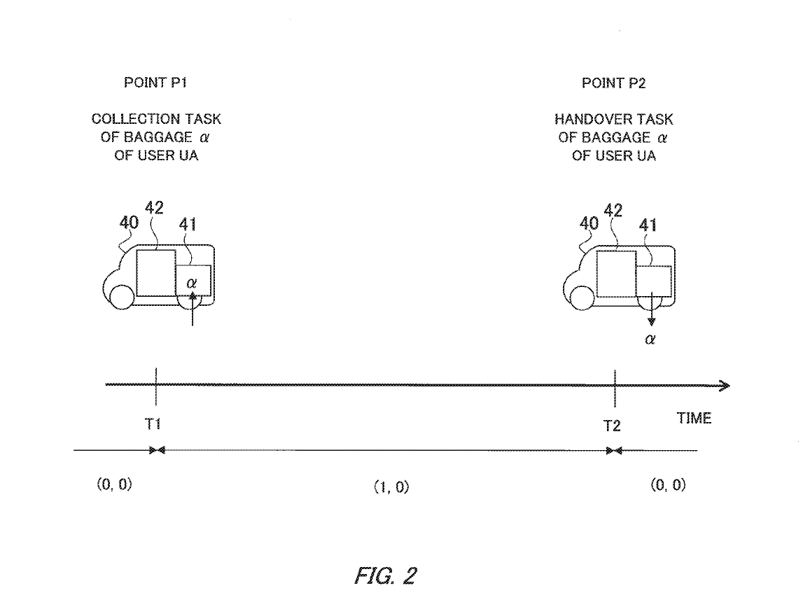

An example of a basic flow of the collection and delivery service assumed by the baggage collection and delivery system according to the first embodiment will be described with reference to FIG. 2. In the example shown in FIG. 2, a baggage α of the user UA is delivered from a point P1 to a point P2. The point P1 corresponds to (ii) baggage leaving point and the point P2 corresponds to (iii) baggage receiving point. The collection task of the baggage α at the point P1 is carried out at time T1. Time T1 corresponds to (v) baggage leaving time. The handover task of the baggage α at the point P2 is carried out at time 12. Time T2 corresponds to (vi) baggage receiving time. As shown in the lower part of FIG. 2, the usage status (41, 42) before Time T1 is (0, 0). The usage status (41, 42) from time T1 to time T2 which is a period for a delivery task of the baggage α is (1, 0). The usage status (41, 42) after time T2 is (0, 0).

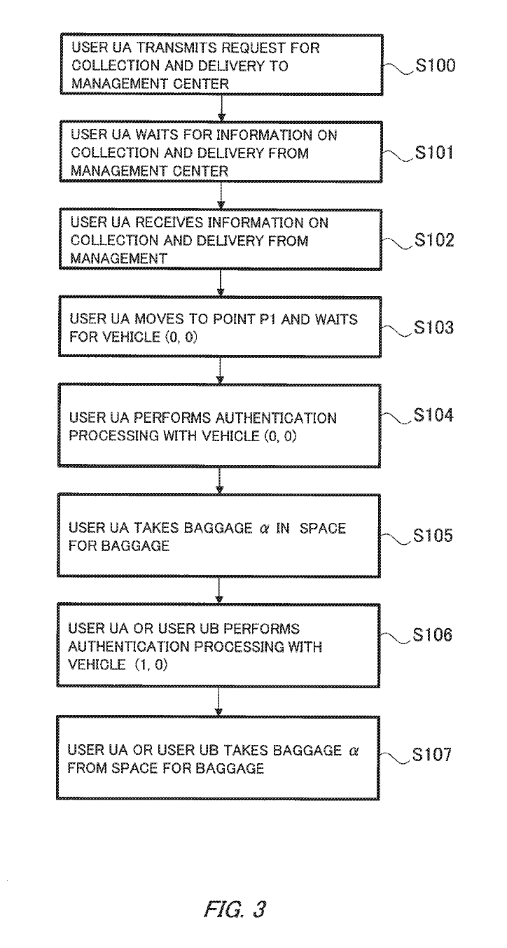

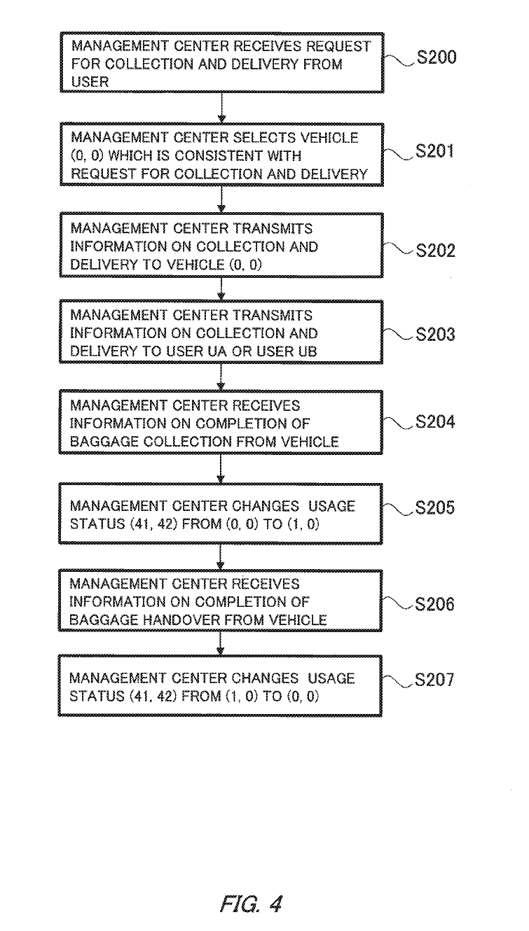

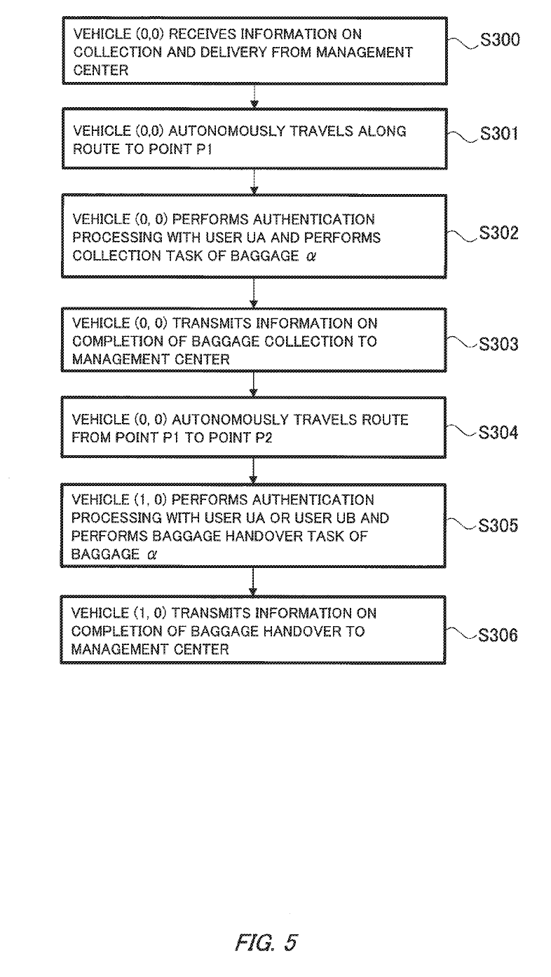

An example of a processing flow of the collection and delivery service according to the first embodiment will be described with reference to FIGS. 3 to 5. FIG. 3 is a diagram for showing an example of a flow of processing in the mobile terminal 30 of the user UA (the mobile terminals 30 of the users UA and UB, when the user UB is present) constituting the baggage collection and delivery system 1. FIG. 4 is a flowchart for showing a flow of processing in the management center 10 (the management server 20) constituting the baggage collection and delivery system 1. FIG. 5 is a flowchart for showing a flow of processing in the vehicle 40 constituting the baggage collection and delivery system 1.

The processing of the baggage collection and delivery system shown in FIGS. 3 to 5 is started when the user UA starts up the application 31 to transmit the request for collection and delivery to the management center 10. As shown in FIG. 3, the user UA transmits the request for collection and delivery to the management center 10 (step S100), and waits for the information on collection and delivery from the management center 10 (step S101). The request for collection and delivery transmitted in step S100 includes the information (i) to (vi) described above.

When the management center 10 receives the request for collection and delivery, the processing shown in FIG. 4 is started. As shown in FIG. 4, when the management center 10 receives the request for collection and delivery from the user UA (step S200), it selects the vehicle 40 (0, 0) which is consistent with the request for collection and delivery (step S201). In the selection processing in step S201, the request for collection and delivery and information stored in the database of the management server 20 are used. After selecting the vehicle 40 (0, 0), the management center 10 transmits the information on collection and delivery ((i) user ID information of the user UA, (ii) baggage leaving point, (iii) baggage receiving point or the like) to the same vehicle 40 (0, 0) (step S202). In addition, the management center 10 transmits the information on collection and delivery (ID information of the vehicle for collection and delivery) to the user UA (step S203). When the user UB is present, the information on collection and delivery is transmitted to the user UB.

When the mobile terminal 30 of the user UA receives the information on collection and delivery, the processing from step S103 shown in FIG. 3 is started. As shown in FIG. 3, when the user UA receives the information on collection and delivery from the management center 10 (step S102), the user UA moves to the point P1 and waits for the vehicle 40 (0, 0) (step S103). Also, when the vehicle 40 (0, 0) receives the information on collection and delivery, the processing from step S300 shown in FIG. 5 is started. As shown in FIG. 4, when the vehicle 40 (0, 0) receives the information on collection and delivery from the management center 10 (step S300), it autonomously travels along the route from its present point to the point P1 (step S301).

At the point P1, when authentication processing is carried out between the user UA and the vehicle 40 (0, 0), it is possible for the user UA to take the baggage α (see FIG. 2) in the space for baggage 41. As shown in FIG. 3, the user UA performs authentication processing with the vehicle 40 (0, 0) (step S104) and takes the baggage α in the space for baggage 41 (step S105). Also, as shown in FIG. 5, the vehicle 40 (0, 0) performs authentication processing with the user UA and performs the collection task of the baggage α (step S302). After completion of the collection task, the vehicle 40 (0, 0) transmits information on completion of baggage collection to the management center 10 (step S303) and then autonomously travels the route from the point P1 to the point P2 (step S304).

When the management center 10 receives the information of the completion of baggage collection, processing from step S204 in FIG. 4 is started. As shown in FIG. 4, when the management center 10 receives the information of the completion of baggage collection from the vehicle 40 (step S204), it changes the usage status (41, 42) of the same vehicle 40 (0, 0) from (0, 0) to (1, 0) (step S205).

When the vehicle 40 reaches the point P2 (see FIG. 2), it is possible for the user UA (or the user UB) to take the baggage α from the space for baggage 41. As shown in FIG. 3, the user UA (or the user UB) performs authentication processing with the vehicle 40 (1, 0) (step S106) and takes the baggage α from the space for baggage 41 (step S107). Also, as shown in FIG. 5, the vehicle 40 (1, 0) performs authentication processing with the user UA (or the user UB) and performs the handover task of the baggage α (step S305). After completion of the handover task, the vehicle 40 (1, 0) transmits information on completion of baggage handover to the management center 10 (step S306).

When the management center 10 receives the information of the completion of baggage handover, the processing from step S206 in FIG. 4 is started. As shown in FIG. 4, when the management center 10 receives the information of the completion of baggage handover from the vehicle 40 (step S206), it changes the usage status (41, 42) of the same vehicle 40 (1, 0) from (1, 0) to (0, 0) (step S207).

### 3. Characteristic of the Baggage Collection and Delivery System According to the First Embodiment

The collection and delivery service described with reference to FIG. 2 assumes a case where the period for the collection and delivery task (i.e. period from time T1 to time T2) is relatively short (for example, several hours). However, when the period for the collection and delivery task becomes long (for example, when it exceeds 12 hours), difference between time T2 and the estimated time at which the vehicle 40 (1, 0) reaches the point P2 becomes large. This large time difference means that the vehicle 40 (1, 0) waits for a long time for the execution of the handover task of the baggage α. Then, the longer time the vehicle 40 (1, 0) waits for, the lower earning rate of the collection and delivery service becomes. Therefore, in the first embodiment, the space for ride 42 of the vehicle 40 (1, 0) being engaged in the delivery task is provided to the transportation service for other users than the user UA. If the space for ride 42 of the vehicle 40 (1, 0) is provided to the transportation service for other users, it is possible to make up for a decline in the earning rate of the collection and delivery service by the transportation service. If the occupancy rate of the space for ride 42 is increased, it also be possible to increase the total revenue of the service.

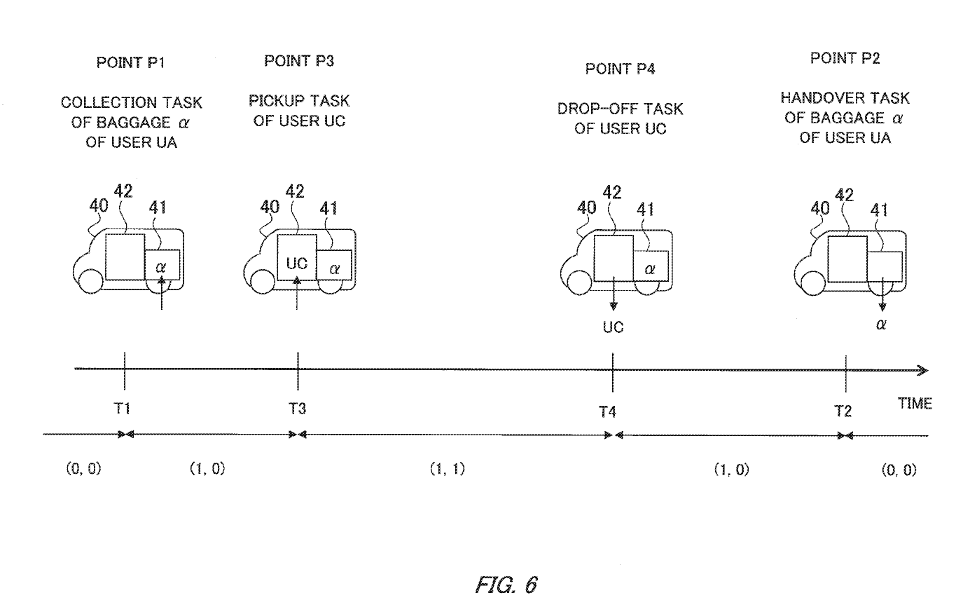

The characteristic of the baggage collection and delivery system according to the first embodiment will be described with reference to FIG. 6. In the example shown in FIG. 6, the baggage α of the user UA is delivered from the point P1 to the point P2. The collection task of the baggage α at the point P1 is carried out at time T1. The handover task of the baggage α at the point P2 is carried out at time T2. Up to this point, it is the same as the flow of the collection and delivery service described with reference to FIG. 2.

In the baggage collection and delivery system according to the first embodiment, the transportation service of a user UC is carried out from time T1 to time T2 in addition to the performance of the collection and delivery service. A transportation task of the user UC is carried out between a point P3 and a point P4. A pickup task of the user UC at the point P 3 is carried out at time T3. A drop-off task of the user UC at the point P4 is carried out at time T4. The point P3 corresponds to (viii) pickup point described later, and the point P4 corresponds to (ix) drop-off point described later. As shown in the lower part of FIG. 6, the usage state (41, 42) from time T1 to time T3 is (1, 0). The usage status (41, 42) from time T3 to time T4 is (1, 1). The usage status (41, 42) from time T4 to time T2 is (1, 0).

In the first embodiment, the vehicle management portion 21 shown in FIG. 1 is further configured to execute, in addition to the processing (A) to (C) described above, processing to accept a request for transportation (hereinafter also referred to as “(D) Reception processing”) and processing to select a vehicle for transportation of the user UC (hereinafter also referred to as “(E) Selection processing”) and processing to generate information on transportation (hereinafter also referred to as “(F) Generation processing”).

(D) Reception processing is processing to accept the request for transportation transmitted from the mobile terminal 30 of the user UC via the network 2. The request for transportation accepted by (D) Reception processing includes, for example, the following information on (vii) to (x).

(vii) user ID information of the user UC
(viii) pickup point at which the user UC wants to ride
(ix) drop-off point at which the user UC wants to drop off
(x) pickup time during which the user UC wants to ride

(E) Selection processing is processing to select the vehicle for transportation of the user UC based on the request for transportation and information stored in the database of the management server 20. In (E) Selection processing, at first, the vehicles 40 (1, 0) which are able to reach (viii) pickup point by (x) pickup time are extracted. Subsequently, one vehicles 40 (1, 0) which has the shortest autonomous travel time of route to (viii) pickup point is extracted from the extracted vehicles 40 (1, 0). Subsequently, time required for the transportation service (the transportation task) of the extracted vehicle 40 (1, 0) is calculated and it is determined whether or not the extracted vehicle 40 (1, 0) reach (iii) delivery address before (vi) receipt time. Then, if the determination result is positive, the extracted vehicle 40 (1, 0) is selected as the vehicle for transportation. The time required for the transportation service is calculated under an assumption that the extracted vehicle 40 (1, 0) normally travels a route from its present point to (iii) baggage receiving point via (viii) pickup point and (ix) drop-offpoint.

If the determination result is negative, one vehicle 40 (1, 0) which has the second shortest autonomous travel time of route to (viii) pickup point is extracted from the extracted vehicles 40 (1, 0). And a determination on the time required for the transportation service (the transportation task) of the extracted vehicle 40 (1, 0) is carried out. By repeating such the extraction of the vehicle 40 (1, 0) and the determination on the time required for the transportation service, the vehicle for transportation is selected. If there is no vehicle 40 (1, 0) which satisfies these conditions, the vehicle for transportation is selected from the vehicles 40 (0, 0).

(F) Generation processing is processing to generate the information on transportation which is transmitted to the vehicle for transportation and also for the mobile terminal 30 of the user UC. The information for the vehicle for transportation includes an instruction for transportation. The instruction for transportation includes, for example, (vii) user ID information of the user UC and (viii) pickup point. The information for the mobile terminal 30 of the user UC includes, for example, ID information of the vehicle for transportation and estimated times at which the same vehicle reaches (viii) pickup point and (xi) drop-off point, respectively. The estimated time at which the vehicle for transportation reaches (vii) pickup point is calculated under an assumption that the same vehicle travels a route from its present point to (vii) pickup point. The estimated time at which the vehicle for transportation reaches (ix) drop-off point is calculated under an assumption that the same vehicle normally travels a route from (vii) pickup point to (ix) drop-off point.

In the first embodiment, the communication portion 22 shown in FIG. 1 is configured to transmit the information on transportation described above to the mobile terminals 30 of the user UC and the vehicle for transportation via the network 2.

In the first embodiment, each of the vehicles 40 is configured to travel autonomously a route from its present area to the destination based on the information on transportation and various information described above. The various information for the autonomous travel has already been explained. The functions of the ECU 50 of the vehicle 40 for the autonomous travel is used not only for the collection and delivery service described above but also for the transportation service.

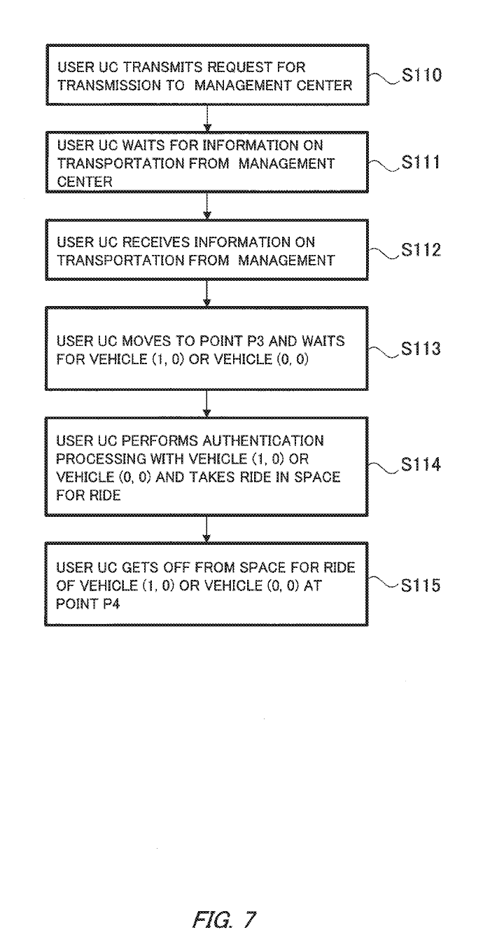

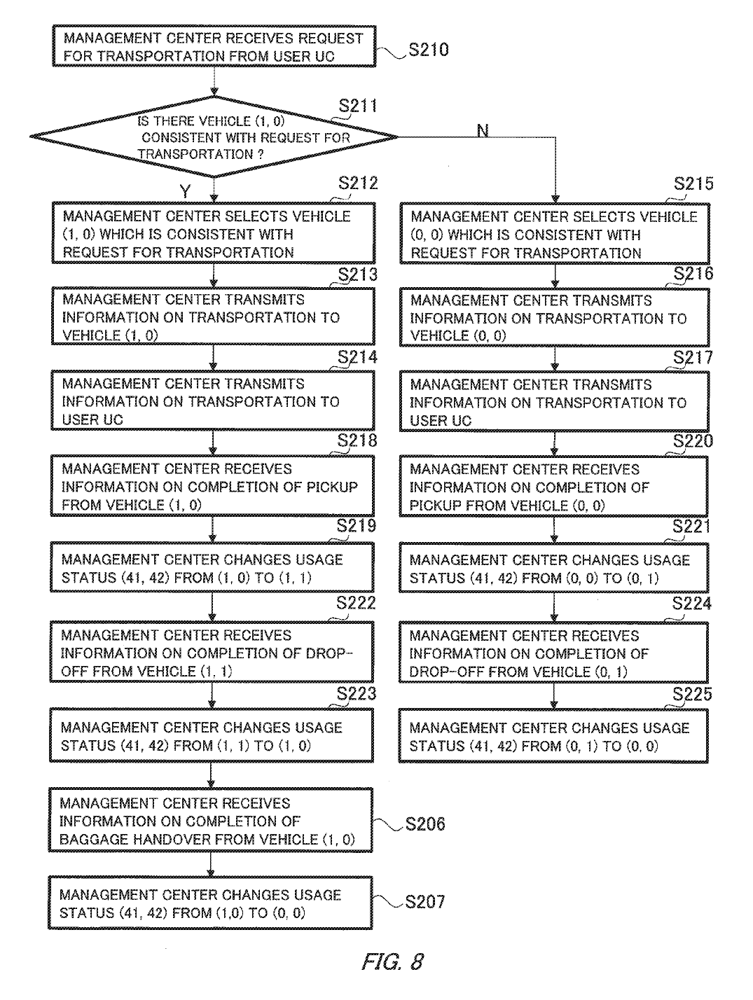

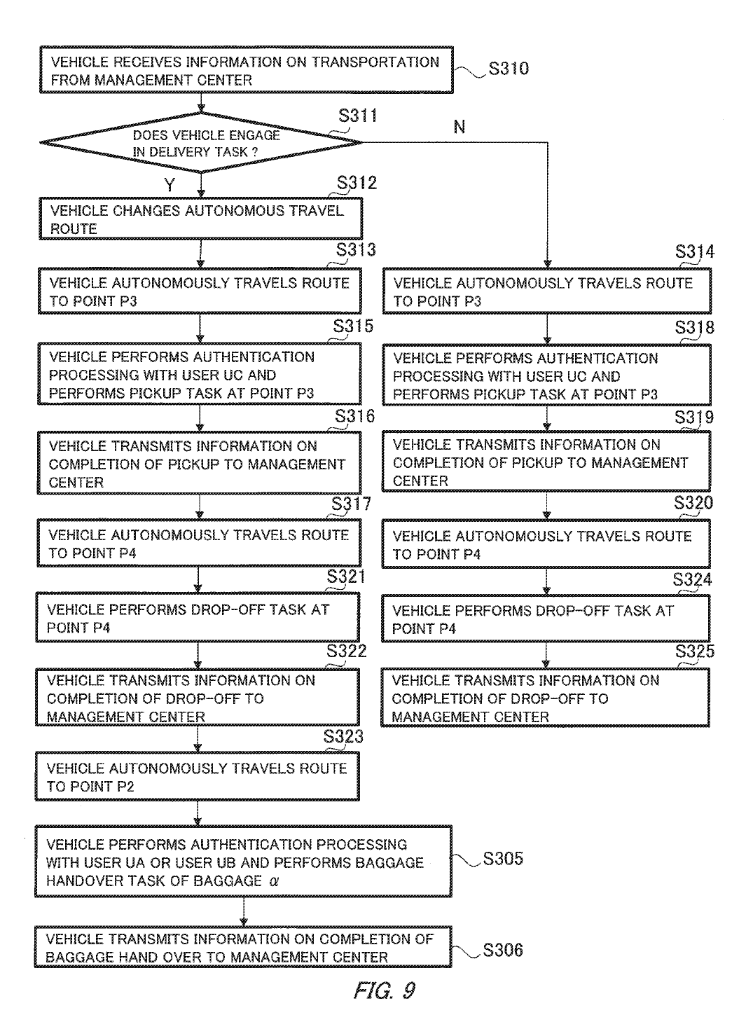

An example of a basic flow of the collection and delivery service performed by the baggage collection and delivery system according to the first embodiment will be described with reference to FIGS. 7 to 9. FIG. 7 is a diagram for explaining a flow of processing in the mobile terminal of the user UC constituting the baggage collection and delivery system 1. FIG. 8 is a diagram for explaining a flow of processing in the management center 10 constituting the baggage collection and delivery system 1. FIG. 9 is a diagram for explaining a flow of processing in the vehicle 40 constituting the baggage collection and delivery system 1. In the flowcharts shown in FIGS. 8 and 9, the same step numbers are assigned to processing having the same contents as the flowcharts shown in FIGS. 4 and 5.

The processing of the baggage collection and delivery system shown in FIGS. 7 to 9 is started when the user UC starts up the application 31 to transmit the request for transportation to the management center 10. As shown in FIG. 3, the user UC transmits the request for transportation to the management center 10 (step S110), and waits for the information on transportation from the management center 10 (step S111). The request for transportation transmitted in step S110 includes the information (vii) to (ix) described above.

When the management center 10 receives the request for transportation, the processing shown in FIG. 8 is started. As shown in FIG. 8, when the management center 10 receives the request for transportation from the user UC (step S210), it determines whether the vehicle 40 (1, 0) is present which is consistent with the request for transportation (step S211). When the determination result of the step S211 is positive, the management center 10 selects the vehicle 40 (1, 0) which is consistent with the request for transportation as the vehicle for transportation (step S212) and transmits the information on transportation (the instruction for transportation) to the selected vehicle 40 (1, 0) (step S213). Also, the management center 10 transmits the information on transportation (for example, ID information of the vehicle for transportation) to the user UC (step S214). When the determination result of the step S211 is negative, the management center 10 selects the vehicle 40 (0, 0) which is consistent with the request for transportation as the vehicle for transportation (step S215) and transmits the information on transportation to the selected vehicle 40 (0, 0) (step S216). Also, the management center 10 transmits the information on transportation (for example, ID information of the vehicle for transportation) to the user UC (step S217).

When the mobile terminal 30 of the user UC and the vehicle 40 receive the information on transportation, the processing from step S112 shown in FIG. 7 and processing shown in FIG. 9 are started. As shown in FIG. 7, when the user UC receives the information on transportation from the management center 10 (step S112), he/she moves to the point P3 (see FIG. 6) and waits for a vehicle for transportation (step S113). As shown in FIG. 9, when the vehicle 40 receives the information on transportation from the management center 10 (step S310), it determines whether or not the vehicle 40 engages in a delivery task of the baggage (step S311). In the step S311, the vehicle 40 performs the determination processing based on whether or not the instruction for collection and delivery is exist without information on completion of baggage handover.

When the determination result of the step S311 is positive, the vehicle 40 changes the autonomous travel route (step S312) and autonomously travels the route from its present point to the point P3 (step S313). That is, the transportation task of the user UC is carried out in preference to execution of the delivery task of the baggage α. When the determination result of the step S311 is negative, the vehicle 40 autonomously travels the route from its present point to the point P3 (step S314).

At the point P3, when authentication processing is carried out between the user UC and the vehicle 40, the user is able to get on the vehicle 40. As shown in FIG. 7, the user UC performs authentication processing with the vehicle 40 (1, 0) (or the vehicle 40 (0, 0)) and then takes a ride in the same vehicle 40 (step S114). As shown in FIG. 9, the vehicle 40 (1, 0) (or the vehicle 40 (0, 0)) performs authentication processing with user UC and performs pickup task of the user UC (step S315). Upon completion of the pickup task, the vehicle 40 (1, 0) transmits information on completion of pickup to the management center 10 (step S316) and autonomously travels the route to the drop-off area (step S317). In the case of the vehicle 40 (0, 0), processing similar to the processing in steps S315 to S317 is carried out in steps S318 to S320.

When the management center 10 receives information on completion of pickup, the processing from step S218 or S220 shown in FIG. 8 started. As shown in FIG. 8, when the management center 10 receives information on completion of pickup from the vehicle 40 (1, 0) (step S218), it 10 changes the usage status (41, 42) from (1, 0) to (1, 1) (Step S219). When the management center 10 receives information on completion of pickup from the vehicle 40 (0, 0) (step S220), it changes the usage status (41, 42) from (0, 0) to (0, 1) (step S221).

When the vehicle 40 reaches the point P4 (see FIG. 6), the processing of step S115 shown in FIG. 7 and the processing from step S321 in FIG. 9 are started. As shown in FIG. 7, the user UC gets off the vehicle 40 (1, 1) (or the vehicle 40 (0, 1)) (step S115). As shown in FIG. 9, the vehicle 40 (1, 1) performs drop-off processing of the user UC at point P4 (step S321) and transmits information on completion of drop-off to management center 10 (step S322). Then, the vehicle 40 (1, 1) autonomously travels the route from its present point to the point P2 (see FIG. 6) (step S323). That is, execution of the delivery task of the baggage α is restarted. In the case of the vehicle 40 (0, 1), processing similar to the processing in steps S321 and S322 is carried out in steps S324 and S325.

When the management center 10 receives information on completion of drop-off, the processing from step S222 or S224 shown in FIG. 8 is started. As shown in FIG. 8, when the management center 10 receives information on completion of drop-off from the vehicle 40 (1, 1) (step S222), it changes the usage status (41, 42) from (1, 1) to (1, 0) (Step S223). When the management center 10 receives information on completion of drop-off from the vehicle 40 (0, 1) (step S224), it changes the usage status (41, 42) from (0, 1) to (0, 0) (step S225).

### 4. Effects According to the Baggage Collection and Delivery System

In the baggage collection and delivery system according to the first embodiment described above, the transportation service with the space for ride 42 of the vehicle 40 (1, 0) is carried out during the collection and delivery service. Therefore, it is possible to effectively increase the total revenue of the service by effectively utilizing the space for ride 42 of the vehicle 40 (1, 0).

### Second Embodiment

### 1. Premise of the Collection and Delivery Service According to a Second Embodiment

In the first embodiment described above, it is assumed that the collection and delivery service is carried out when the user UA does not ride in the vehicle 40 while the baggage α is delivered from (ii) baggage leaving point to (iii) baggage receiving point. In the second embodiment, it is premised that the collection and delivery service is carried out when the user temporarily uses the space for ride 42 during the space for baggage 41 is used for depositing his/her baggage. Such a collection and delivery service is carried out when, for example, a user who takes a ride in the space for ride 42 of the vehicle 40 to a tourist spot while depositing his/her baggage in the space for baggage 41 of the same vehicle 40 to send it to his/her accommodation.

In the second embodiment, the vehicle management portion 21 shown in FIG. 1 is configured to execute processing to accept a request for collection and delivery of a baggage and for transportation of a user (hereinafter also referred to as “request for transportation, collection and delivery”) (hereinafter also referred to as “(G) Reception processing”), processing to select a vehicle for collection and delivery of the baggage (hereinafter also referred to as “(H) Selection processing”) and processing to generate information on collection and delivery of the baggage (hereinafter also referred to as “(I) Generation processing”).

(G) Reception processing is processing to accept the request for transportation, collection and delivery transmitted from the mobile terminal 30 of the user via the network 2. The request for transportation, collection and delivery accepted by (G) Reception processing includes, for example, the following information on (xi) to (xvii). (xi) user ID information of a sender of the baggage (hereinafter also referred to as “user UD”)

(xii) baggage leaving point
(xiii) baggage receiving point
(xiv) user ID information of a receiver of the baggage (hereinafter also referred to as “user UE”)
(xv) baggage leaving time desired by the user UD
(xvi) baggage receiving time desired by the user UD
(xvii) drop-offpoint desired by the user UD

If the user UD and the user UE are the same user, (xiv) user ID information of the user UE may not be included in the request for transportation, collection and delivery. If the user UD and the user UE are different user, (xiv) user ID information of the user UE may be specified by the vehicle management portion 21, which is executed in the same manner as the (iv) user ID information of the user UB described above.

(H) Selection processing is processing to select the vehicle for collection and delivery based on the request for transportation, collection and delivery and information stored in the database of the management server 20. (H) Selection processing is basically the same as (B) Selection processing described above.

(I) Generation processing is processing to generate the information on collection and delivery of the baggage which is transmitted to the vehicle for collection and delivery and also to the mobile terminals 30 of the users UD and UE. The information for the vehicle for collection and delivery includes the instruction for collection and delivery. The instruction for collection and delivery includes, for example, (xi) user ID information of the user UD, (xii) baggage leaving point, (xiii) baggage receiving point and (xiv) user ID information of the user UE. The information for the mobile terminal 30 of the user UD includes, for example, ID information of the vehicle for collection and delivery and estimated times at which the same vehicle reaches (xii) baggage leaving point and (xiii) baggage receiving point, respectively. The information for the mobile terminal 30 of the user UE includes, for example, ID information of the vehicle for collection and delivery and estimated time at which the same vehicle reaches (xiii) baggage receiving point. The estimated time at which the vehicle for collection and delivery reaches (xii) baggage leaving point is calculated under an assumption that the same vehicle normally travels a route from its present point to (xii) baggage leaving point. The estimated time at which the vehicle for collection and delivery reaches (xiii) baggage receiving point is calculated under an assumption that the same vehicle normally travels a route from (xii) baggage leaving point to (xiii) baggage receiving point.

The communication portion 22 shown in FIG. 1 is configured to transmit the information on collection and delivery described above to the mobile terminals 30 of the users UD and UE and the vehicle for collection and delivery via the network 2.

### 2. Example of a Basic Flow of the Collection and Delivery Service

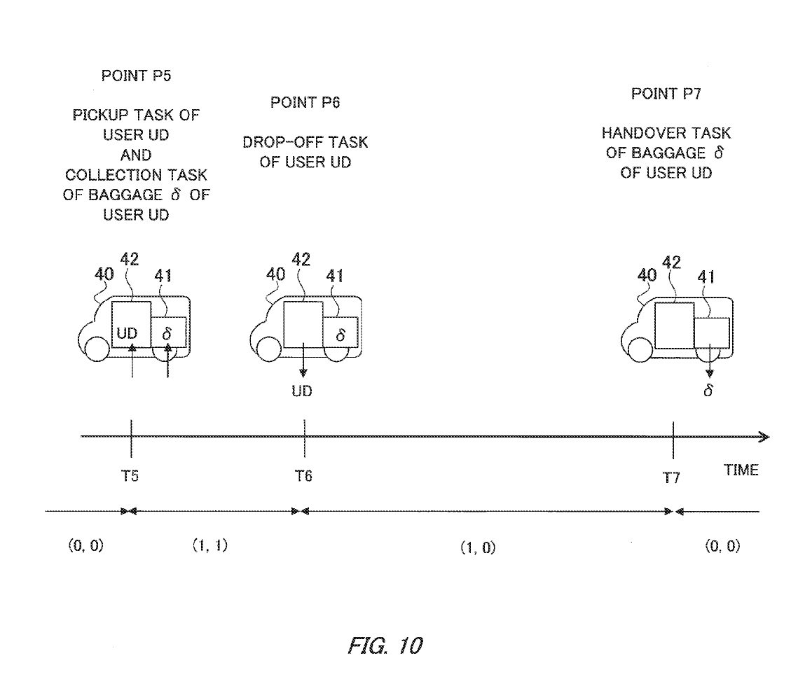

An example of a basic flow of the collection and delivery service assumed by the baggage collection and delivery system according to the second embodiment will be described with reference to FIG. 10. In the example shown in FIG. 10, a baggage δ of the user UD is delivered from a point P5 to a point P7 via a point P6. The point P5 corresponds to (vii) baggage leaving point, the point P6 corresponds to (xvii) drop-off point, and the point P7 corresponds (xiii) baggage receiving point.

A collection task of the baggage δ at the point P5 is carried out at time T5. Time T5 corresponds to (xv) baggage leaving time. A drop-off task of the user UD at the point P6 is carried out at time T6. A handover task of the baggage δ at the point P7 is carried out at time T7. Time T7 corresponds to (xvi) baggage receiving time.

As shown in the lower part of FIG. 10, the usage status (41, 42) before Time T5 is (0, 0). The usage status (41, 42) from time T5 to time T6 where the user UD who deposits the baggage δ in the space for baggage 41 takes a ride in the space for ride 42 is (1, 1). The usage status (41, 42) from time T6 to time T7 which is a period for the delivery task of the baggage δ is (1, 0). The usage status (41, 42) after time T7 is (0, 0).

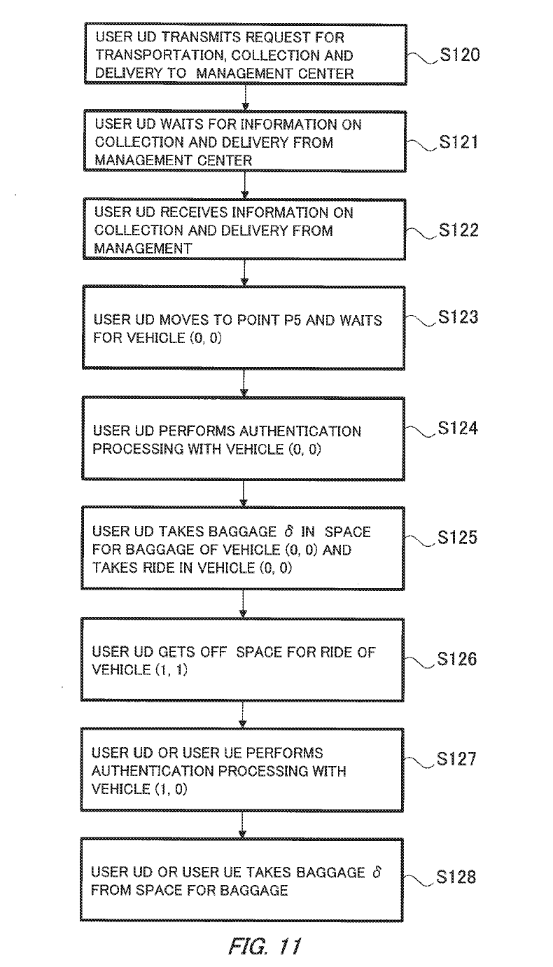

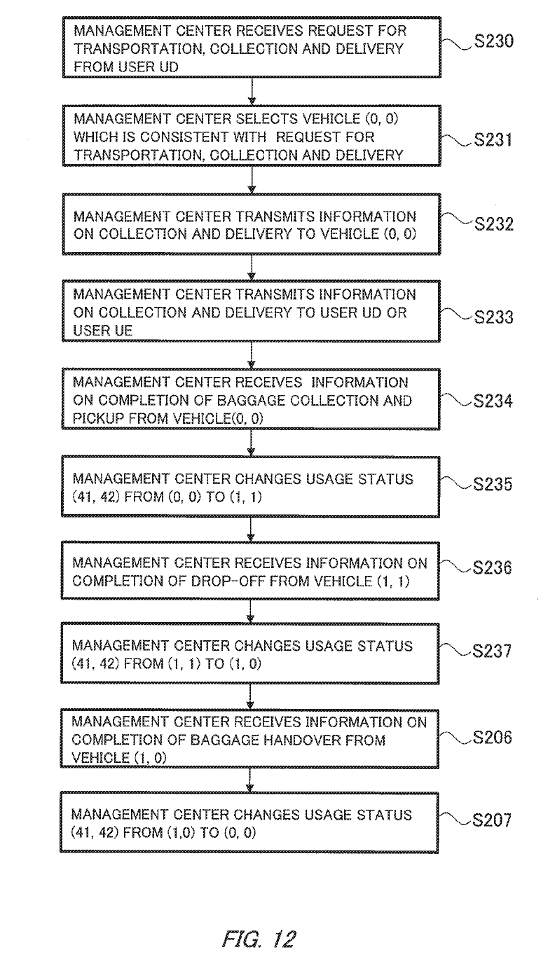

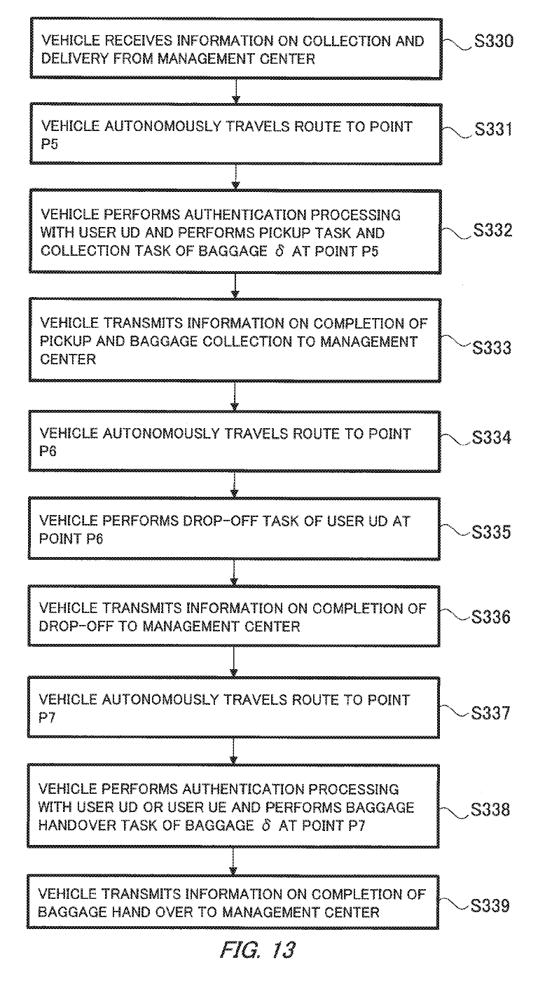

An example of a processing flow of the collection and delivery service according to the second embodiment will be described with reference to FIGS. 11 to 13. FIG. 11 is a diagram for showing an example of a flow of processing in the mobile terminal 30 of the user UD (the mobile terminals 30 of the users UD and UE, when the user UE is present) constituting the baggage collection and delivery system 1. FIG. 12 is a flowchart for showing a flow of processing in the management center 10 constituting the baggage collection and delivery system 1. FIG. 13 is a flowchart for showing a flow of processing in the vehicle 40 constituting the baggage collection and delivery system 1. In the flowchart shown in FIG. 12, the same step numbers are assigned to processing having the same contents as the flowchart shown in FIG. 4.

The processing of the baggage collection and delivery system shown in FIGS. 11 to 13 is started when the user UD starts up the application 31 to transmit the request for transportation, collection and delivery to the management center 10. As shown in FIG. 11, the user UD transmits the request for transportation, collection and delivery to the management center 10 (step S120), and waits for the information on transportation, collection and delivery from the management center 10 (step S121). The request for transportation, collection and delivery transmitted in step S120 includes the information (xi) to (xvii) described above.

When the management center 10 receives the request for transportation, collection and delivery, the processing shown in FIG. 12 is started. As shown in FIG. 12, when the management center 10 receives the request for transportation, collection and delivery from the user UD (step S230), it selects the vehicle 40 (0, 0) which is consistent with the request for transportation as the vehicle for transportation, collection and delivery (step S231). After the selection of the vehicle 40 (0, 0) for transportation, collection and delivery, the management center 10 transmits the information on collection and delivery ((xi) user ID information of the user UD, (xii) baggage leaving point, (xiii) baggage receiving point, (xvii) drop-offpoint and the like) to the selected vehicle 40 (0, 0) (step S232). Also, the management center 10 transmits the information on collection and delivery (for example, ID information of the vehicle for transportation) to the user UD (step S233). When the user UE is present, the management center 10 further transmits the information on collection and delivery to the user UE.

When the mobile terminal 30 of the user UD receives the information on collection and delivery, the processing from step S122 shown in FIG. 11 is started. As shown in FIG. 11, when the user UD receives the information on collection and delivery from the management center 10 (step S122), he/she moves to the point P5 (see FIG. 10) and waits for the vehicle (0, 0) (step S123). When the vehicle 40 (0, 0) receives the information on collection and delivery from the management center 10, the processing shown in FIG. 13 is started. As shown in FIG. 13, when the vehicle 40 (0, 0) receives the information on collection and delivery from the management center 10 (step S330), it autonomously travels a route from its present point to the point P5 (step S331).

When authentication processing between the user UD and the vehicle 40 (0, 0) is carried out at the point P5, it is possible for the user UD to take the baggage δ in the space for baggage 41. As shown in FIG. 11, the user UD performs authentication processing with the vehicle 40 (0, 0) (step S124), takes the baggage δ in the space for baggage 41 and also takes a ride in the space for ride 42 (step S125). Also, as shown in FIG. 13, the vehicle 40 (0, 0) performs authentication processing with the user UD and performs the collection task of the baggage δ and the pickup task of the user UD (step S332). After completion of the collection task and the pickup task, the vehicle 40 (0, 0) transmits information on completion of baggage collection and pickup to the management center 10 (step S333) and then autonomously travels the route from the point P5 to the point P6 (see FIG. 10) (step S334).

When the management center 10 receives information on completion of baggage collection and pickup, the processing from step S234 shown in FIG. 12 is started. As shown in FIG. 12, when the management center 10 receives information on completion of baggage collection and pickup from the vehicle 40 (0, 0), it changes the usage status (41, 42) of the same vehicle 40 (0, 0) from (0, 0) to (1, 0) (step S235).

When the vehicle 40 reaches the point P6, the processing of step S126 shown in FIG. 11 and the processing from step S335 shown in FIG. 13 are started. As shown in FIG. 11, the user UD gets off the vehicle 40 (1, 1) (step S126). As shown in FIG. 13, the vehicle 40 (1, 1) performs the drop-off task of the user UD at the point P6 (step S335) and transmits information on completion of drop-off to the management center 10 (step S336). Then, the vehicle 40 (1, 1) autonomously travels the route from the point P6 to the point P7 (see FIG. 10) (step S337).

When the management center 10 receives information on completion of drop-off, the processing from step S236 shown in FIG. 12 is started. As shown in FIG. 12, when the management center 10 receives information on completion of drop-off from the vehicle 40 (1, 1), it changes the usage status (41, 42) of the same vehicle 40 (1, 1) from (1, 1) to (1, 0) (step S237).

When the vehicle 40 reaches the point P7, it is possible for the user UD (or the user UE) to take the baggage δ from the space for baggage 41. As shown in FIG. 11, the user UD (or the user UE) performs authentication processing with the vehicle 40 (1, 0) (step S127) and takes the baggage δ from the space for baggage 41 (step S128). Also, as shown in FIG. 13, the vehicle 40 (1, 0) performs authentication processing with the user UD (or the user UE) and performs the handover task of the baggage δ (step S3337). After completion of the handover task, the vehicle 40 (1, 0) transmits information on completion of baggage handover to the management center 10 (step S339).

### 3. Characteristic of the Baggage Collection and Delivery System According to the Second Embodiment

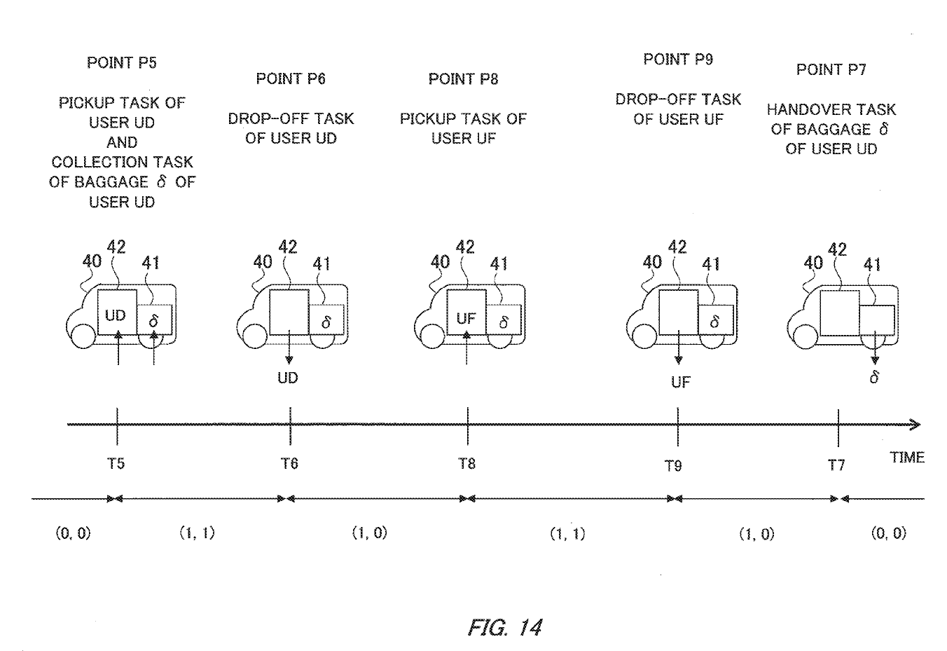

In the baggage collection and delivery system according to the second embodiment, the space for ride 42 after the drop-off of the user UD is provided to other transportation services other than the user UD. The characteristic of the baggage collection and delivery system according to the second embodiment will be described with reference to FIG. 14. In the example shown in FIG. 14, the baggage δ of the user UD is delivered from the point P5 to the point P7. The collection task of the baggage δ at the point P5 is carried out at time T5. The drop-off task of the user UD at the point P6 is carried out at time T6. The handover task of the baggage δ at the point P7 is carried out at time T7. Up to this point, it is the same as the flow of the transportation, collection and delivery service described with reference to FIG. 10.

In the baggage collection and delivery system according to the second embodiment, the transportation service of a user UF is carried out from time T6 to time T7 in addition to the transportation, collection and delivery service. A transportation task of the user UF is carried out from a point P8 to a point P9. A pickup task of the user UF at the point P8 is carried out at time T8. The drop-off task of the user UF at point P9 is carried out at time T9. The point P8 corresponds to (xix) pickup point described later, and the point P9 corresponds to (xx) drop-off point described later. As shown in the lower part of FIG. 14, the usage state (41, 42) from time T6 to time T8 is (1, 0). The usage status (41, 42) from time T8 to time T9 is (1, 1). The usage status (41, 42) from time T9 to time T7 is (1, 0).

In the second embodiment, the vehicle management portion 21 shown in FIG. 1 is further configured to execute, in addition to the processing (G) to (I) described above, processing to accept the request for transportation (hereinafter also referred to as “(J) Reception processing”) and processing to select a vehicle for transportation of the user UF (hereinafter also referred to as “(K) Selection processing”) and processing to generate information on transportation (hereinafter also referred to as “(L) Generation processing”).

(J) Reception processing is processing to accept the request for transportation transmitted from the mobile terminal 30 of the user UF via the network 2. The request for transportation accepted by (J) Reception processing includes, for example, the following information on (xviii) to (xxi).

(xviii) user ID information of the user UF
(xix) pickup point at which the user UF wants to ride
(xx) drop-off point at which the user UF wants to drop off
(xxi) pickup time during which the user UF wants to ride

(K) Selection processing is processing to select the vehicle for transportation of the user UF based on the request for transportation and information stored in the database of the management server 20. (K) Selection processing is basically the same as (E) Selection processing described above.

(L) Generation processing is processing to generate information for the vehicle for collection and delivery and also for the mobile terminal 30 of the user UF. (L) Generation processing is basically the same as (F) Generation processing described above.

In the second embodiment, the communication portion 22 shown in FIG. 1 is configured to transmit the information on transportation described above to the mobile terminals 30 of the user UF and the vehicle for transportation via the network 2.

In the second embodiment, each of the vehicles 40 is configured to travel autonomously the route from its present area to the destination based on the information on transportation and various information described above. The various information for the autonomous travel has already been explained. The functions of the ECU 50 of the vehicle 40 for the autonomous travel is used not only for the collection and delivery service described above but also for the transportation service.

The explanation of FIGS. 7 to 9 may be diverted for an example of the flow of processing which is carried out in the baggage collection and delivery system according to the second embodiment. In this diversion case, “the user UA” will be read as “the user UD”, “the user UB” will be read as “the user UE” and “the user UC” will be read as “the user UF”. Also, “the point P3” will be read as “the point P8” and “the point P4” will be read as “the point P9” in the diversion case.

### 4. Effects According to the Baggage Collection and Delivery System

In the baggage collection and delivery system according to the second embodiment described above, the transportation service with the space for ride 42 of the vehicle 40 (1, 0) is carried out after a user who uses the space for ride 41 temporarily in conjunction with the usage of the space for baggage 42 gets off the vehicle 40 (1, 1). Therefore, it is possible to effectively increase the total revenue of the service by effectively utilizing the space for ride 42 of the vehicle 40 (1, 0).

### Third Embodiment

### 1. Characteristic of the Baggage Collection and Delivery System According to a Third Embodiment

In the baggage collection and delivery system according to the first embodiment described above, the space for ride 42 of the vehicle 40 (1, 0) is automatically provided to the transportation service. In the baggage collection and delivery system according to the third embodiment, an approval for provision of the vehicle 40 (1, 0) to the transportation service is collected as one item of the request for collection and delivery. Also, an approval for use of the vehicle 40 (1, 0) in the transportation service is collected as one item of the request for transportation. That is, approval information of the user UA or UC for a parallel processing of baggage delivery task and the transportation task is collected. Further, in the third embodiment, a charge for use the collection and delivery service is set based on the collected approval information. The processing to set the charge for use the collection and delivery service is carried out as a part of (B) Selection processing by the vehicle management portion 21 shown in FIG. 1. The processing to set the charge for use the collection and delivery service is also carried out as a part of (E) Selection processing.

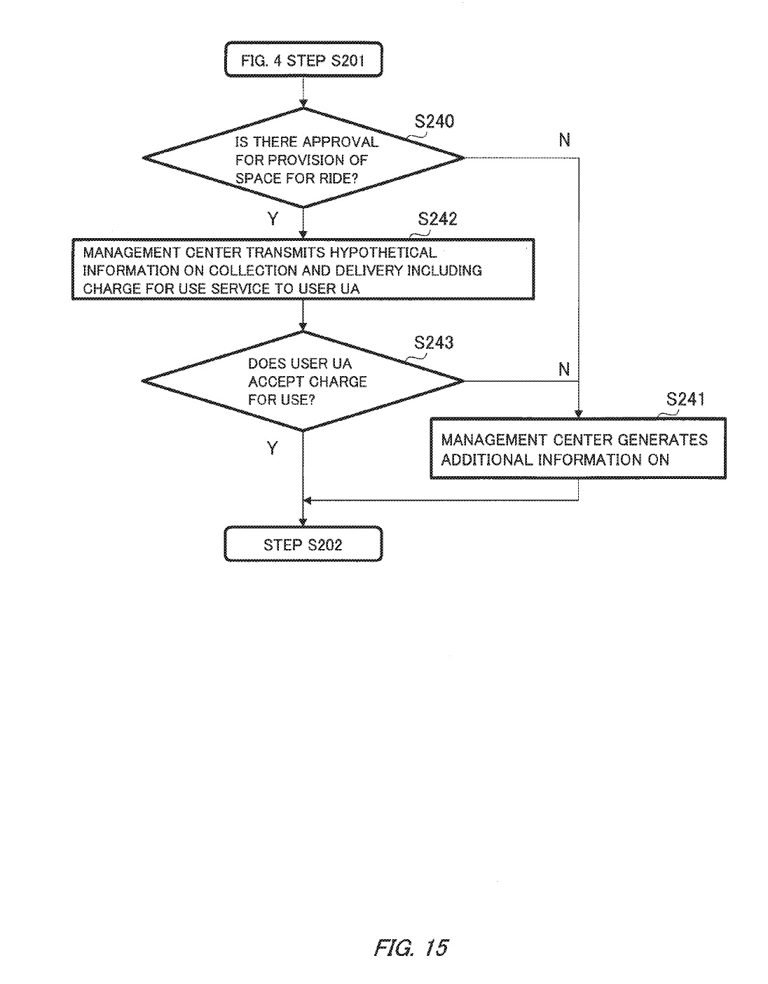

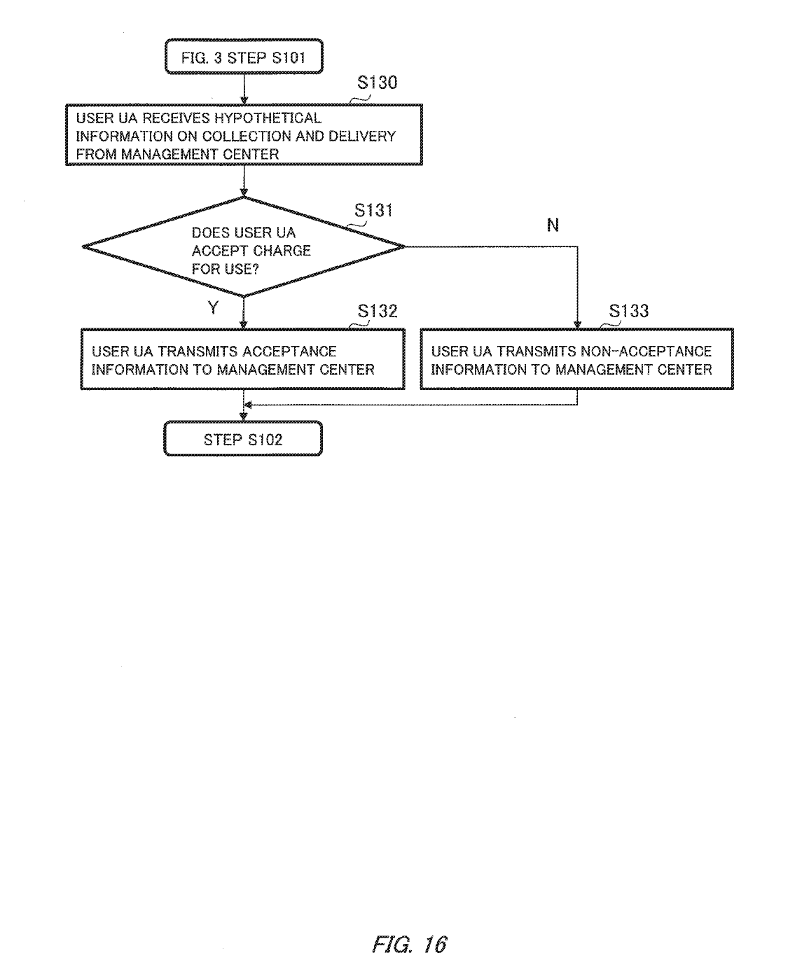

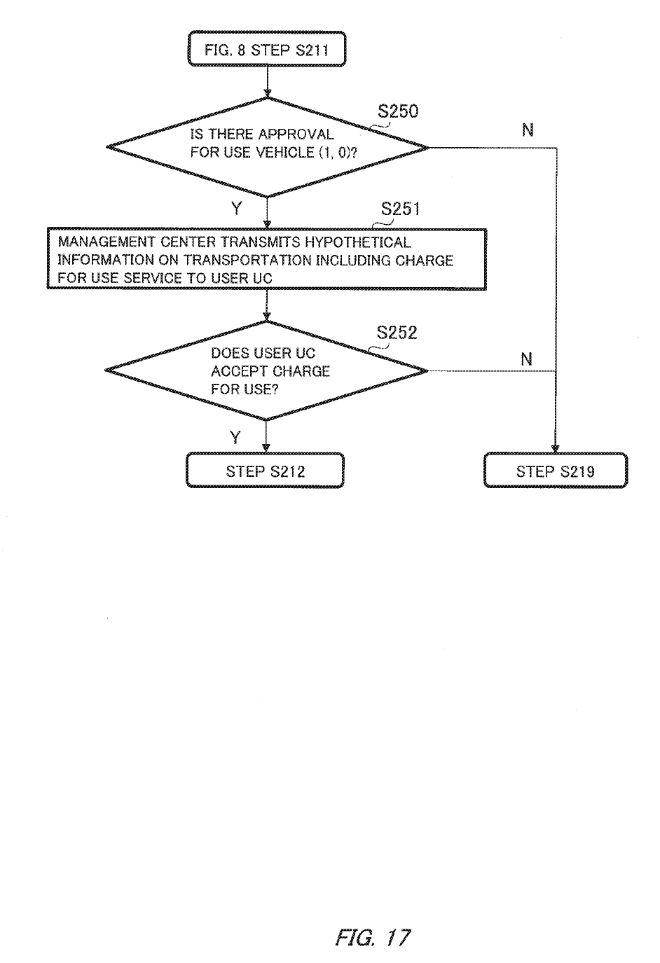

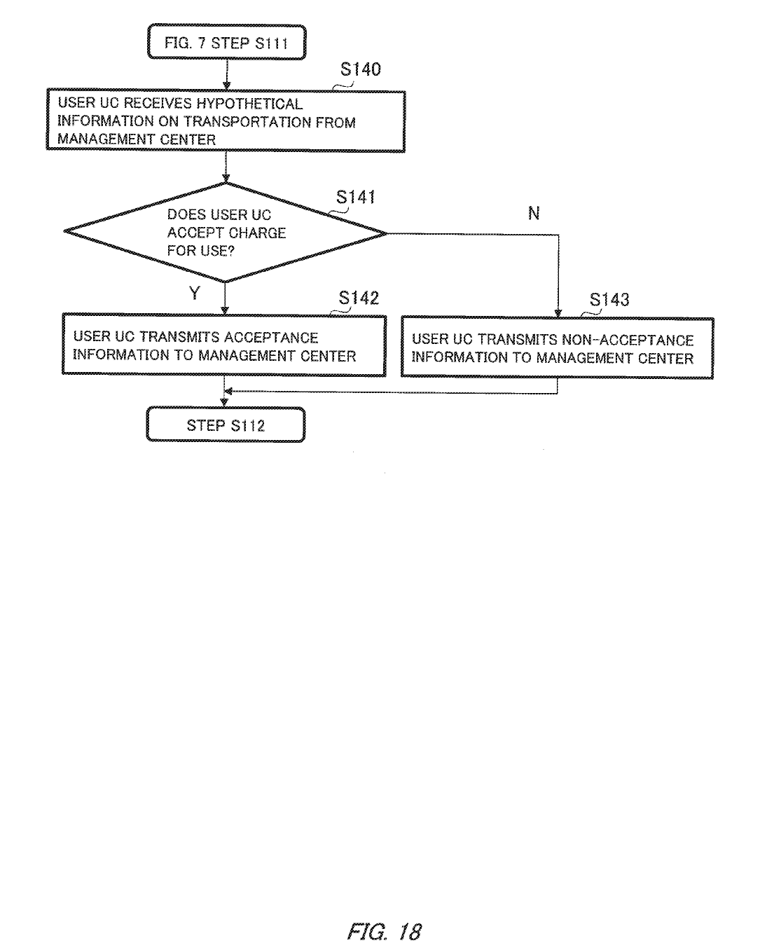

An example of a process flow of the collection and delivery service performed by the baggage collection and delivery system according to the third embodiment will be described with reference to FIGS. 15 to 18. FIGS. 15 and 17 are flowcharts for showing a flow of processing in the management center 10 constituting the baggage collection and delivery system 1. FIG. 16 is a flowchart for showing a flow of processing in the mobile terminal 30 of the user UA constituting the baggage collection and delivery system 1. FIG. 18 is a flowchart for showing a flow of processing in the mobile terminal of the user UC constituting the baggage collection and delivery system 1.

The flowchart shown in FIG. 15 is started following the processing of the step S201 of FIG. 4. First, the management center 10 determines whether there is the approval for provision of the space for ride 42 to the transportation service (step S240). The presence or absence of the approval for the provision is determined based on information which is included in the request for collection and delivery. When the determination result of the step S240 is negative, additional information is generated to the effect that the vehicle 40 (0, 0) selected in the step S201 is not provided for the transportation service (step S241). When the additional information is generated, for example, the usage status (41, 42) is changed from (0, 0) to (0, −). By setting the usage status (41, 42) to (0, −), the provision of the vehicle 40 (1, 0) to the transportation service is prohibited. When the determination result of the step S240 is positive, a hypothetical information on collection and delivery including the charge for use the collection and delivery service is transmitted to the user UA (step S242).

The charge for use the collection and delivery service consists of a basic charge and discount of the service. The discount of the service is a charge deducted from the basic charge where the vehicle 40 (1, 0) is provided for the transportation service. When the mobile terminal 30 of the user UA receives the hypothetical information on collection and delivery, the processing shown in FIG. 16 is started. As shown in FIG. 16, when the mobile terminal 30 of the user UA receives the hypothetical information on collection and delivery from the management center 10 (step S130), it determines whether or not to accept the charge for use the collection and delivery service (step S131). When accepting the charge for use the collection and delivery service, acceptance information is transmitted to the management center 10 (step S132). When the charge for use the collection and delivery service is not accepted, non-acceptance information is transmitted to the management center 10 (step S133).

When the management center 10 receives a reply from the mobile terminal 30 of the user UA, the processing of step S243 shown in FIG. 15 is started. As shown in FIG. 15, the management center 10 determines whether or not the user UA accept the charge for use the collection and delivery service (step S243). When the determination result of the step S243 is negative, the management center 10 performs processing shown in the step S241, and then proceeds to processing in the step S202 shown in FIG. 4. On the other hand, when the determination result or the step S243 is positive, the management center 10 proceeds directly to processing in the step S202.

The flowchart shown in FIG. 17 is started following the processing of the step S211 shown in FIG. 8. First, the management center 10 determines whether there is the approval for use the space for ride 42 of the vehicle 40 (1, 0) in the transportation service (step S250). The presence or absence of the approval for use is determined based on the information which is included in the request for transportation. When the determination result of the step S250 is negative, the management center 10 proceeds to processing of the step S219 shown in FIG. 8 irrespective of the determination result of the step S211. When the determination result of the step S250 is positive, a hypothetical information on transportation including the charge for use the transportation service is transmitted to the user UC (step S252).

The charge for use the transportation service consists of a basic charge and discount of the service. The discount for the service is a charge deducted from the basic charge where the user UC uses the vehicle 40 (1, 0). When the mobile terminal 30 of the user UC receives the hypothetical information on transportation, processing shown in FIG. 18 is started. As shown in FIG. 18, when the mobile terminal 30 of the user UC receives the hypothetical information on transportation (step S140), it determines whether or not to accept the charge for use the transportation service (step S141). When accepting the charge for use the transportation service, acceptance information is transmitted to the management center 10 (step S142). When the charge for use the transportation is not accepted, non-acceptance information is transmitted to the management center 10 (step S143).

When the management center 10 receives a reply from the mobile terminal 30 of the user UC, the processing of step S252 shown in FIG. 17 is started. As shown in FIG. 17, the management center 10 determines whether or not the user UC accept the charge for use the transportation service (step S252). When the determination result of the step S252 is negative, the management center 10 proceeds to processing of the step S219 shown in FIG. 8 irrespective of the determination result of the step S211. When the determination result of the step S252 is positive, the management center 10 proceeds directly to processing of the step S212.

### 2. Effects According to the Baggage Collection and Delivery System

In the baggage collection and delivery system according to the third embodiment described above, the charge for use the collection and delivery service is set based on the approval information included in the request for collection and delivery and also the charge for use the transportation service is set based on the approval information included in the request for transportation. Therefore, it is possible for the users UA and UC to enjoy the benefit of the parallel processing for using respective service at a cheaper price than the basic charge. Further, it is possible to promote reuse of these services. Therefore, it is possible to increase the total revenue of the service.

### Other Embodiments

The baggage collection and deliver system according to each of the embodiments described above may be modified as follows.

For example, face authentication by a camera sensor may be used as a method for user authentication. Specifically, a face picture of the user photographed with the camera sensor of the mobile terminal 30 is transmitted to the management center 10 at an admission to the collection and delivery service and the face picture is registered in the database of the management server 20. Then, when the user uses the collection and delivery service or the transportation service, the facial photograph data is added to the information on collection and delivery which is transmitted to the vehicle 40 by the management center 10. The user authentication portion 53 collates a photograph of a person in the vicinity of the vehicle 40 photographed by the camera sensor of the vehicle 40 with the facial photograph data from the management server 20. And if the photograph matches the facial photograph data, the user authentication portion 53 recognizes the person as the user who has transmitted the various request (i.e. the request for collection and delivery, the request for transportation and the request for transportation, collection and delivery).

As another method of user authentication, authentication using proximity wireless communication such as FeliCa (registered trademark) or NFC may be used. In this case, the mobile terminal 30 has a proximity wireless communication function or a dedicated IC card, and the vehicle 40 has a communication device for proximity wireless communication outside the vehicle 40. The user authentication portion 53 collates ID information of the mobile terminal 30 obtained from the management server 20 with ID information directly obtained from the mobile terminal 30 or the from the IC card by the proximity wireless communication. If ID information from the management server 20 matches the ID information from the mobile terminal 30 or the IC card, the user authentication portion 53 recognizes the person who has the mobile terminal 30 or the IC card as the user who has transmitted the various request described above.

What is claimed is:

1. A baggage collection and delivery system comprising:
a plurality of automatic drive vehicles, each of which is configured to travel autonomously and includes a space for baggage and a space for ride;
a mobile terminal belonging to a user, and
a management center which is configured to communicate via a network to the automatic drive vehicle and the mobile terminal,
wherein the management center is further configured to:
when receiving a request for collection and delivery including a collection address and a delivery address of a baggage from the mobile terminal of a first user, select from the automatic drive vehicles a vehicle for collection and delivery whose the space for baggage and the space for ride are available;
transmit to the vehicle for collection and delivery an instruction for collection and delivery based on the request for collection and delivery;
when receiving a request for transportation including a pickup point and drop-off point baggage from the mobile terminal of a second user, select from the automatic drive vehicles a vehicle for transportation whose the space for ride is at least available; and
transmit to the vehicle for transportation an instruction for transportation based on the request for transportation,
wherein the vehicle for collection and delivery is configured to:
when receiving the instruction for transportation while performing a delivery task of the baggage in accordance with the instruction for collection and delivery, perform a transportation task of the second user in accordance with the instruction for transportation in priority to the delivery task; and
perform the delivery task after the completion of the transportation task.

2. The baggage collection and delivery system according to claim 1,
wherein the management center is further configured to, in the selection processing, when a candidate of the vehicle for transportation is the vehicle for collection and delivery, determine, based on time required for the transportation task, on whether the candidate reaches the delivery address before the receipt time of the baggage.

3. The baggage collection and delivery system according to claim 1,
wherein the request for collection and delivery further includes information on whether or not parallel processing of a baggage delivery task and a user transportation task is permitted,
wherein the management center is further configured to, when the approval information on parallel processing is included in the collection and delivery request, transmit to the mobile terminal of the first user basic charge and discount of a service by the vehicle for collection and delivery.

4. The baggage collection and delivery system according to claim 1,
wherein the request for transportation further includes information on whether or not parallel processing of a baggage delivery task and a user transportation task is permitted,
wherein the management center is further configured to, when the approval information on parallel processing is included in the request for transportation, transmit to the mobile terminal of the second user basic charge and discount of a service by the vehicle for transportation.
